(19) United States
(12) Patent Application Publication
(10) Pub. No.: US 2026/0067968 A1
(43) Pub. Date: Mar. 5, 2026

(54) PROCESS FOR COUPLING FUNCTIONAL UNITS, SYSTEM AND FUNCTIONAL UNIT

(71) Applicant: Drägerwerk AG & Co. KGaA, Lübeck (DE)

(72) Inventor: Folke WILL, Lübeck (DE)

(21) Appl. No.: 19/311,128

(22) Filed: Aug. 27, 2025

(30) Foreign Application Priority Data
Sep. 2, 2024 (DE) 10 2024 125 025.9

(51) Int. Cl. H04W 76/15; H04B 5/40; H04W 28/18

(52) U.S. Cl. CPC H04W 76/15; H04B 5/40; H04W 28/18

(57) ABSTRACT

A process couples functional units that are configured to communicate wirelessly with each other. The process includes establishing a first wireless communication link (5) between a first primary functional unit (1) and a second primary functional unit (2). The first primary functional unit is coupled to a secondary functional unit (3). Coupling information is transmitted (4) from the first primary functional unit to the second primary functional unit via the first wireless communication link. The coupling information includes coupling data for coupling with the secondary functional unit. The second primary functional unit is coupled to the secondary functional unit based on the coupling information to establish a second wireless communication link (6). A functional unit (9) as well as a system, including a medical device (7) and/or a sensor (8) or personal protective equipment, a gas measuring device, and/or a gas sensor, carry out the process.

### CROSS REFERENCE TO RELATED APPLICATIONS

This application claims the benefit of priority under 35 U.S.C. § 119 of German Application 10 2024 125 025.9, filed Sep. 2, 2024, the entire contents of which are incorporated herein by reference.

### TECHNICAL FIELD

The present invention relates to a process for coupling (pairing) functional units, in particular a process for changing a coupling status of functional units, wherein the functional units are configured to communicate wirelessly with each other. The invention also relates to a functional unit, a system comprising a medical device and/or a sensor, and a system comprising personal protective equipment, a gas measuring device, and/or a gas sensor.

### BACKGROUND

Often, two or more functional units, i.e., devices that perform a specific task in a respective application area, such as sensors, actuators, or control units, are networked with each other for data exchange, wherein they are configured to communicate wirelessly with each other. Networking a plurality of functional units results in an extended area of application, which is usually accompanied by an improved solution to the respective application-specific task.

A scenario frequently encountered in practice is the networking of different functional units, for example one or more sensors with a control unit, a monitoring unit, a data evaluation unit, and/or a display unit. The one or more sensors transmit measured values via an interface for wireless communication, for example to the data evaluation unit for further processing of the measured values. An example of a networked system in the field of medical technology is an incubator and one or more sensors for measuring vital parameters, wherein the sensor(s) send measured values to the incubator. Furthermore, in the field of safety technology, i.e., in the field of personal protection or buildings and facilities, gas measuring devices with a control room for transmitting gas measurements are networked, or functional units of personal protective equipment, such as a digital level indicator for a compressed air breathing apparatus with a head-up display on a gas mask, wherein the head-up display shows the level measurements received from the digital level indicator. In both examples, the functional units that are to communicate with each other are usually specified before the data exchange by coupling the corresponding functional units with each other.

One advantage of functional units that communicate wirelessly is their flexibility of use, as their locations within the radio range can be chosen freely and are not limited by cables. It is usually necessary to specify which functional units are to communicate with each other and exchange data. In practice, this is done by coupling, also known as pairing, two or more functional units. When coupling functional units that are configured to communicate wirelessly with each other, coupling information is exchanged between the functional units, enabling further data exchange. The coupling information is stored in at least one of the functional units so that the respective functional unit can identify the other functional unit intended or units intended for communication and exchange data with the one or more other coupled functional units. In other words, coupling determines the communication partners for data exchange.

It is advisable that only those functional units that belong together in terms of the application are coupled with each other. This is particularly necessary because there are often a plurality of functional units in a transmission and/or reception area that do not all belong together. Therefore, the correct coupling of functional units is an essential task in the aforementioned application scenarios from the fields of medical technology and safety technology.

Such a coupling of functional units can be carried manually, wherein two functional units intended for communication are coupled by a user by selecting the respective functional units. This is time-consuming and requires technical knowledge that is often not necessary for the intended use of the functional unit and usually has to be acquired additionally by the user of the respective functional unit. Furthermore, manually initiated coupling can lead to errors, resulting in incorrect or unintentional coupling between functional units that do not belong together. This is made more difficult, especially when there are a large number of functional units in a radio range, by the fact that the user must know or be able to identify the functional units to be coupled. In this case, the functional units usually have to have a visible and distinguishable identifier or a screen that allows the functional units to be distinguished from one another. However, not every functional unit has a screen, and attaching an individual identifier to a large number of functional units is very time-consuming and, under certain circumstances, prone to errors.

A common way of coupling functional units in practice is to hold the respective functional units to be coupled together, whereupon these functional units are then coupled to each other. One problem with this is that the functional units to be coupled are not always flexible enough in terms of location to allow them to be held together. Furthermore, local conditions may make it difficult or, depending on the application scenario, undesirable to hold the functional units to be coupled and intended for application-related data exchange together.

### SUMMARY

Based on the solutions known from the prior art and the problems described above, the invention is based on the task of providing an improved process for coupling functional units, wherein the functional units are configured to communicate with each other wirelessly. In particular, it should be possible to replace an already coupled functional unit with another functional unit in a simple and reliable manner. Furthermore, it should be possible to add another functional unit to a network of a plurality of already coupled functional units so that the additional functional unit can exchange data with the already coupled functional units. Systems and a functional unit configured to carry out such a process are also provided.

The above object is attained by a process with features as disclosed herein, a system comprising a medical device and/or a sensor for detecting vital parameters with features as disclosed herein, a system comprising personal protective equipment, a gas measuring device and/or a gas sensor with features as disclosed herein, and a functional unit with features as disclosed herein. Further details of the invention are provided in the claims, the description, and the drawings. Features and details described in connection with the process according to the invention also apply in connection with the systems and the functional unit according to the invention, so that mutual reference is always made, or rather can be made, to the disclosure of the individual aspects of the invention.

The process according to the invention for coupling functional units that are configured to communicate wirelessly with each other comprises the following steps:
Establishing a first wireless communication link (communication connection) between a first primary functional unit and a second primary functional unit, wherein the first primary functional unit is coupled to a secondary functional unit
Transmitting coupling information from the first primary functional unit to the second primary functional unit via the first wireless communication link, wherein the coupling information comprises at least coupling data configured to couple with the secondary functional unit
Coupling the second primary functional unit to the secondary functional unit based on the coupling information to establish a second wireless communication link.

Coupling, also referred to as pairing, of functional units that are configured to communicate wirelessly with each other is understood as a communication-related networking of these functional units. In the case of coupled functional units, at least one of the functional units knows information for identifying another functional unit, which enables direct communication between the one and the other functional unit.

A functional unit within the meaning of the invention is understood to be a device that performs a specific task in a particular field of application, such as medical technology or safety technology. In the fields of medical technology and safety technology in particular, the task of a functional unit is to support or protect a person. Functional units are preferably suited to detecting and/or influencing parameters in the environment of the functional unit. Furthermore, in addition to fulfilling the task in the respective field of application, the functional units are configured to communicate wirelessly and, for example, exchange data with other functional units. Functional units from the field of medical technology, in particular ventilators, anesthesia devices, incubators, or sensors for measuring vital parameters, are usually used for therapeutic or diagnostic purposes. Functional units from the field of safety technology, in particular gas measuring devices, gas sensors or components of personal protective equipment, on the other hand, are configured to protect one or more persons, in particular from dangerous concentrations of gases or gas mixtures.

The functional unit preferably comprises at least one control unit, for example in the form of a microprocessor, for processing data, and at least one data memory. Furthermore, the functional unit comprises at least one communication unit for wireless communication.

According to the invention, functional units are to be subdivided into two groups, namely those of the primary functional units and those of the secondary functional units, wherein the primary functional units and the secondary functional units are configured to be coupled to one another. Coupling within the meaning of the invention is only intended between one or a plurality of primary functional units and one or a plurality of secondary functional units. Coupling of a plurality of primary functional units with each other or of a plurality of secondary functional units with each other is conceivable, but not relevant according to the invention. The primary functional units are configured to communicate wirelessly with each other, in particular without prior coupling, and also with secondary functional units. Furthermore, secondary functional units are configured to communicate wirelessly both with each other, in particular without prior coupling, and with primary functional units. An essential aspect of the invention is the transmission and transfer of coupling information from a first primary functional unit to a second primary functional unit and the subsequent coupling of the second primary functional unit with a secondary functional unit on the basis of the coupling information.

The purpose of the process according to the invention is to couple the second primary functional unit to the secondary functional unit, wherein the secondary functional unit is already coupled to the first primary functional unit. It is conceivable that the first primary functional unit was coupled to the secondary functional unit at an earlier point in time using the process according to the invention or using a process known from the prior art.

In a first step of the process, the first communication link is established between the first primary functional unit coupled to the secondary functional unit and the second primary functional unit. Preferably, the first communication link is established without coupling the first and second primary functional unit. For example, the establishment of the first communication link is initiated by bringing the first primary functional unit and the second primary functional unit into a common radio range. It is also conceivable that the establishment of the first communication link merely comprises the recognition of the second primary functional unit by the first primary functional unit or the recognition of the first primary functional unit by the second primary functional unit.

The first communication link established in the first step serves to enable data exchange between primary functional units that are preferably not coupled to each other or are not to be coupled to each other. The first and second primary functional units are located in a common radio range at least temporarily. Preferably, the first communication link is established as soon as the first and second primary functional units are within the same radio range, wherein the second primary functional unit preferably transmits a signal at recurring intervals which can be received by the first primary functional unit as soon as the first and second primary functional units are within the same radio range. It is also conceivable that the first and/or the second primary functional unit are additionally preconfigured (preprogramed) to establish the first communication link with the other primary functional unit.

In a further step of the process, the coupling information is transmitted from the first primary functional unit to the second primary functional unit via the first communication link. It is also conceivable that the second primary functional unit reads the coupling information from the first primary functional unit via the first communication link. In any case, following this step of the process, the coupling information is available to the second primary functional unit for further processing.

The coupling information comprises coupling data of the secondary functional unit. Preferably, the coupling data comprises a unique identifier of the secondary functional unit. The coupling data particularly preferably includes a MAC address (media access control address) with which the secondary functional unit can be identified in a radio range. In particular, the MAC address is a 48-bit data value and/or an address specified for a communication method of the second communication link, such as a Bluetooth MAC address.

Depending on the application, the coupling of the first primary functional unit and the secondary functional unit is maintained after the transmission of the coupling information, or the coupling is released. Whether this coupling remains in place or not is specified to the first primary functional unit and/or the second primary functional unit, for example in the form of configuration parameters. It is also conceivable for the secondary functional unit to have specified whether the coupling of the first primary functional unit and the secondary functional unit is retained or released. In this case, the secondary functional unit is configured, for example, to be coupled with a plurality of primary functional units or with only one primary functional unit. In the first case, the secondary functional unit maintains the coupling with the first primary functional unit during the course of the process, whereas in the second case, the secondary functional unit cancels the coupling with the first primary functional unit, for example, following the coupling of the secondary functional unit with the second primary functional unit. This makes it possible, in an advantageous manner, for the secondary functional unit to be coupled to several primary functional units for data exchange. If, for example, the first primary functional unit is replaced by the second primary functional unit, it is advantageous to disconnect the first primary functional unit from the secondary functional unit.

Based on the coupling data, the second primary functional unit and the secondary functional unit are coupled to each other in a further step of the process. In this step, the second primary functional unit preferably sends a coupling request (pairing request) to the secondary functional unit, which then sends a coupling confirmation to the second primary functional unit.

The second communication link is then established between the coupled second primary functional unit and secondary functional unit, and data is exchanged via the second communication connection. Preferably, this is a bidirectional data exchange and/or a bidirectional communication link. Furthermore, the transmitted data is preferably generated by the second primary functional unit and/or the secondary functional unit, in particular measurement data, control signals and/or data comprising a status of the respective functional unit.

The process according to the invention for coupling functional units that are configured to communicate wirelessly with each other has the particular advantage over known processes in that it is possible to change or replace the communication partner, i.e., one of the already coupled functional units, in a simple and reliable manner. In particular, there is no need to select a communication partner to be coupled, for example by means of a selection menu on a display, since the coupling data is transferred to a new communication partner, in this case to the second primary functional unit.

Another advantage of the process according to the invention is that the secondary functional unit, i.e., the functional unit to be coupled to the second functional unit, does not need to have a visible identifier. Furthermore, the secondary functional unit may initially even be unreachable, since the transmission of the coupling information from the first primary functional unit to the second primary functional unit is independent of the state and/or radio range of the secondary functional unit. Thus, in this case, the second primary functional unit and the secondary functional unit may even be spatially separated from each other or do not have to be located at the same place. Only when the second primary functional unit is coupled with the secondary functional unit do they have to be located in a common radio range.

In a preferred further development of the process, the first wireless communication link is based on a first communication method and the second wireless communication link is based on a second communication method. The second communication method has a greater maximum radio range than the first wireless communication method. Preferably, the second communication method has a range that is a multiple of the maximum range of the first communication method.

The communication methods of the first and second communication links are advantageously different, wherein the first communication method is used primarily for transmitting the coupling information and the second communication method is used for coupling and/or transmitting application data. Application data refers to data that relates to the specific application of the functional units and includes, for example, sensor measurements, status information, control information for electrical stimulation, or similar data.

Another particular advantage of this further development of the process is that the data transmission range of the coupled functional units extends over a large radio range and the coupled functional units can be located at a correspondingly large distance from each other. Another advantage is that data transmission via the second communication link based on the second communication method is not, or at least only to a limited extent, disturbed by communication links based on the first communication method.

The first communication method is preferably based on a Near Field Communication (NFC) standard. Furthermore, the second communication method is preferably based on a Bluetooth standard. NFC and Bluetooth are two international transmission standards. NFC is characterized by a short radio range of up to 10 cm, a low data transmission rate of up to 424 kbit/s, and low energy consumption. Bluetooth is characterized by a radio range of up to 100 m, a data transmission rate of up to 25 Mbit/s, and energy consumption that is three to six times higher than the energy consumption of NFC.

The two transmission standards of the first and second communication methods are advantageously used as required, with NFC being used for energy-efficient transmission of small amounts of data, in particular coupling information, and Bluetooth being used for the transmission of a relatively large amount of application data over a larger radio range.

According to a preferred further development of the process, the coupling information is transmitted from the first primary functional unit to the second primary functional unit as soon as the first primary functional unit and the second primary functional unit are in a near field. The functional units are in a near field when they are spatially close to each other, in particular when their distance from each other is at most equal to the maximum radio range of the first communication method of the first communication link. The first communication method preferably has a short maximum radio range, for example a maximum radio range of 10 cm.

The primary functional units are configured to recognize a primary functional unit located in the near field, preferably by means of the NFC standard, and to transmit the coupling information. This represents a particularly convenient and reliable solution for the user, who, for example, brings the first primary functional unit into close proximity to the second primary functional unit.

In a preferred further development of the process, the data transmitted via the second wireless communication link is generated by the second primary functional unit and/or by the secondary functional unit. For example, the generated data may be sensor measurements, status information, control information for electrical stimulation, or similar application-related data.

According to a preferred further development of the process, the coupling information comprises configuration data, in particular configuration data of the first primary functional unit. Configuration data refers, for example, to settings or parameters of a functional unit, such as a measurement interval of a sensor or an alarm threshold.

This advantageously enables the second primary functional unit, which receives the coupling information with the configuration data, to also adopt and apply the configuration data. This makes it particularly convenient to replace the first primary functional unit with the second primary functional unit. For example, the first and second primary functional units are a sensor with a set measuring range as a parameter. In accordance with this further development of the process, the information about the set measuring range of the first primary functional unit is transmitted together with the coupling data as coupling information to the second primary functional unit, and the second primary functional unit applies this measuring range to further measurements.

In a preferred further development of the process, the secondary functional unit sends at least one identification message, which is received by the second primary functional unit and preferably comprises a MAC address. The second primary functional unit is set up to check, based on the identification message and the coupling data, whether coupling is intended, for example by comparing the MAC address of the identification message with a MAC address of the coupling information. If a coupling is intended and the MAC addresses are identical, for example, a coupling takes place between the second primary functional unit and the secondary functional unit.

In a further preferred embodiment of the process, the second primary functional unit sends at least one coupling request, which is received by the secondary functional unit, wherein the coupling request comprises at least part of the coupling information, in particular the coupling data. The secondary functional unit is set up to check, based on the received coupling information and preferably a MAC address stored in the data memory of the secondary functional unit, whether a coupling is intended, for example by comparing the MAC address of the secondary functional unit with the coupling information, in particular the coupling data in the form of a MAC address. If a coupling is intended and the MAC addresses are identical, for example, a coupling takes place between the second primary functional unit and the secondary functional unit.

According to a preferred further development of the process, the coupling information comprises a universally unique identifier (UUID), wherein the UUID is suitable for identifying and configured to identify a wireless communication link, wherein a unique UUID is assigned to the wireless communication link of a plurality of functional units. The UUID is preferably a 128-bit data value, wherein a unique identifier of the communication link is achieved.

In this embodiment, a UUID is assigned to a communication link of the initially coupled first primary functional unit and the secondary functional unit. For example, the first primary functional unit or the secondary functional unit is configured to generate this UUID and to transmit it to the respective communication partner, i.e., to the secondary functional unit or to the first primary functional unit.

When the coupling information is transmitted from the first primary functional unit to the second primary functional unit, for example as a result of the first primary functional unit and the second primary functional unit being brought into a common near field, the coupling data includes the UUID in addition to or as an alternative to, for example, a MAC address. The second primary functional unit is set up to establish communication with the secondary functional unit based on the UUID. Preferably, the UUID remains in place for the communication link between the second primary functional unit and the secondary functional unit.

In accordance with the previous description, it is also conceivable in this embodiment that the communication link between the first primary functional unit and the secondary functional unit remains in place or is terminated depending on the application. Preferably, the communication link between the first primary functional unit and the secondary functional unit is terminated when the first primary functional unit is replaced by the second primary functional unit for application-related reasons.

Advantageously, the UUID is linked to a communication link and not to a specific functional unit, making the process even more flexible.

In a preferred further development of the process, the coupling of the second primary functional unit and the secondary functional unit is confirmed by an input message at the second primary functional unit and/or by an input message at the secondary functional unit before the second wireless communication link is established. It is conceivable that the input message is generated at the respective functional unit, for example by a user pressing or activating a button, or that the input message is received via an interface for wireless or wired communication.

Advantageously, this further development of the process is even more reliable and flexible, since a user can determine the time of establishing the second communication link himself/herself and/or can check the secondary functional unit and/or the second primary functional unit before establishing the second communication link.

According to a preferred further development of the process, at least the second primary functional unit and the secondary functional unit each comprise an output unit. Furthermore, at least the second primary functional unit and the secondary functional unit are configured to output the same signal via the respective output unit as soon as they are coupled to each other. The output unit is preferably configured to output an optical, acoustic, and/or haptic signal. Preferably, the respective output unit comprises a multicolor LED, and the second primary functional unit and the secondary functional unit output an optical signal in the same color as soon as they are coupled to each other. It is also conceivable that the second primary functional unit and the secondary functional unit output an optical signal that has the same flashing pattern, or that the second primary functional unit and the secondary functional unit output the same haptic and/or acoustic signal in a manner as soon as they are coupled to each other. In any case, the signals output by the second primary functional unit and the secondary functional unit are identical and distinguishable from other signals output by other functional units, and in particular by other coupled functional units that are not coupled to the second primary functional unit or the secondary functional unit.

Preferably, the respective signal is no longer output as soon as the coupling is released. Advantageously, the output of an identical signal allows a user to directly recognize which functional units are coupled to each other.

Furthermore, the invention relates to a system comprising a medical device and/or a sensor for detecting vital parameters, wherein the medical device and/or the sensor are configured to carry out the process according to the invention or one of the previously described further developments of the process.

The medical device and the sensor for detecting vital parameters are to be understood as functional units within the meaning of the invention. Which of these functional units is the first or second primary functional unit or the secondary functional unit depends on the application.

In one application, there is a medical device, for example an incubator, and a first sensor and a second sensor, wherein the first and second sensors are configured as pulse sensors, for example. The first sensor is already coupled to the medical device and is to be replaced by the second sensor. In this application, the medical device is the secondary functional unit, the first sensor is the first primary functional unit, and the second sensor is the second primary functional unit. Coupling information is transmitted from the first sensor to the second sensor, for example because the first sensor and the second sensor are brought into a common near field. Based on the coupling information, the medical device and the second sensor are then coupled together as described above.

Another possible application is one in which a first medical device and a second medical device, for example two incubators, and a sensor, for example a pulse sensor, are present. The sensor is coupled to the first medical device and the first medical device is to be replaced by the second medical device. In this application, the sensor is the secondary functional unit, the first medical device is the first primary functional unit, and the second medical device is the second primary functional unit. Coupling information is transmitted from the first medical device to the second medical device, for example because the first medical device and the second medical device are brought into a common near field. Based on the coupling information, the sensor and the second medical device are then coupled to each other as described above.

Furthermore, the invention relates to a system comprising personal protective equipment, a gas measuring device, and/or a gas sensor, wherein the personal protective equipment, the gas measuring device, and/or the gas sensor are configured to carry out the process according to the invention or one of the further developments of the process described above.

The personal protective equipment, the gas measuring device, and the gas sensor are to be understood as functional units within the meaning of the invention. Which of these functional units is the first or second primary functional unit or the secondary functional unit depends on the application.

For example, the personal protective equipment comprises a first protective helmet with a display and a breathing apparatus with a measurement of the oxygen supply, wherein the current value of the oxygen supply is transmitted to the display via a wireless communication link. For example, the first protective helmet is to be replaced by a second protective helmet. In this case, the breathing apparatus is the secondary functional unit, the first protective helmet is the first primary functional unit, and the second protective helmet is the second primary functional unit.

Furthermore, the invention relates to a functional unit comprising a communication module and a control unit, wherein the control unit is configured to perform the following steps:
Establishing a first wireless communication link with a first primary functional unit, wherein the first primary functional unit is coupled to a secondary functional unit
Receiving coupling information from the first primary functional unit via the first wireless communication link, wherein the coupling information comprises at least coupling data configured to couple with the secondary functional unit
Coupling with the secondary functional unit based on the coupling information to establish a second wireless communication link with the secondary functional unit.

The control unit preferably comprises a microprocessor for processing data and at least one data memory. The communication module is configured to transmit data wirelessly to another communication module via an interface. It is conceivable that the communication module is comprised of the microprocessor or another data processing unit. The communication module is preferably configured to transmit data via Bluetooth or NFC. The communication module is particularly preferably configured to transmit data via Bluetooth and NFC. Other wireless transmission standards are also conceivable.

The terms “functional unit,” “first primary functional unit,” and “secondary functional unit” as used in the invention refer to devices that perform a specific task in a respective area of application. The functional unit is configured here as a second primary functional unit. In the fields of medical technology and safety technology in particular, the task of a functional unit, a first primary functional unit or a secondary functional unit is to support or protect a person. They are preferably configured to detect and/or influence parameters in the environment of the functional unit. In addition to fulfilling the task in the respective areas of application, they are also configured to communicate wirelessly and exchange data. The functional unit, the first primary functional unit or the secondary functional unit is, for example, a ventilator, an anesthesia device, an incubator or a sensor for measuring vital parameters, a gas measuring device, a gas sensor or a component of personal protective equipment.

The purpose of the invention is to couple the functional unit to the secondary functional unit in a reliable and convenient manner, wherein the secondary functional unit is already connected to the first primary functional unit.

An essential aspect of the invention is the receipt of the coupling information from the first primary functional unit by the functional unit, which here assumes the role of the second primary functional unit, and the subsequent coupling of the functional unit with the secondary functional unit on the basis of the coupling information.

The control unit of the functional unit is set up to establish the first communication link between the first primary functional unit coupled to the secondary functional unit and the functional unit. Preferably, the first communication link is established as soon as a common radio range of the first primary functional unit and the functional unit is available.

Furthermore, the control unit is set up to receive coupling information via the communication module and the first communication link from the first primary functional unit. It is also conceivable that the control unit is set up to read the coupling information from the first primary functional unit via the first communication link.

The coupling information comprises coupling data of the secondary functional unit. Preferably, the coupling data comprise a unique identifier of the secondary functional unit. In particular, the coupling data comprise a MAC address (media access control address) with which the secondary functional unit can be identified in a radio range.

The control unit is further configured to couple with the secondary functional unit on the basis of the coupling data and to establish the second communication link. The control unit is preferably configured to send a coupling request to the secondary functional unit via the communication module.

The second communication link is preferably configured for bidirectional data exchange between the functional unit and the secondary functional unit. Furthermore, the transmitted data is preferably generated by the functional unit and/or the secondary functional unit, in particular measurement data, control signals, and/or status data.

Advantageously, the first primary functional unit can be replaced by the functional unit in a simple and reliable manner. In particular, there is no need to select a communication partner to be coupled, for example by means of a selection menu on a display, since the coupling data is transferred to a new communication partner, in this case to the functional unit.

Further features, tasks, and effects of the invention are apparent from the description and the accompanying figures. Examples of embodiments of the invention are described without limiting the general scope of the invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a first primary functional unit, a second primary functional unit and a secondary functional unit;

FIG. 2 is a sequence diagram of an embodiment of the process according to the invention;

FIG. 3 is a schematic view of a system comprising a medical device, a first sensor and a second sensor; and

FIG. 4 is a schematic view of a functional unit.

### DESCRIPTION OF PREFERRED EMBODIMENTS

Referring to the drawings, examples of embodiments of the invention are described in detail below with reference to the accompanying figures. Identical components in several figures are designated by the same reference numerals.

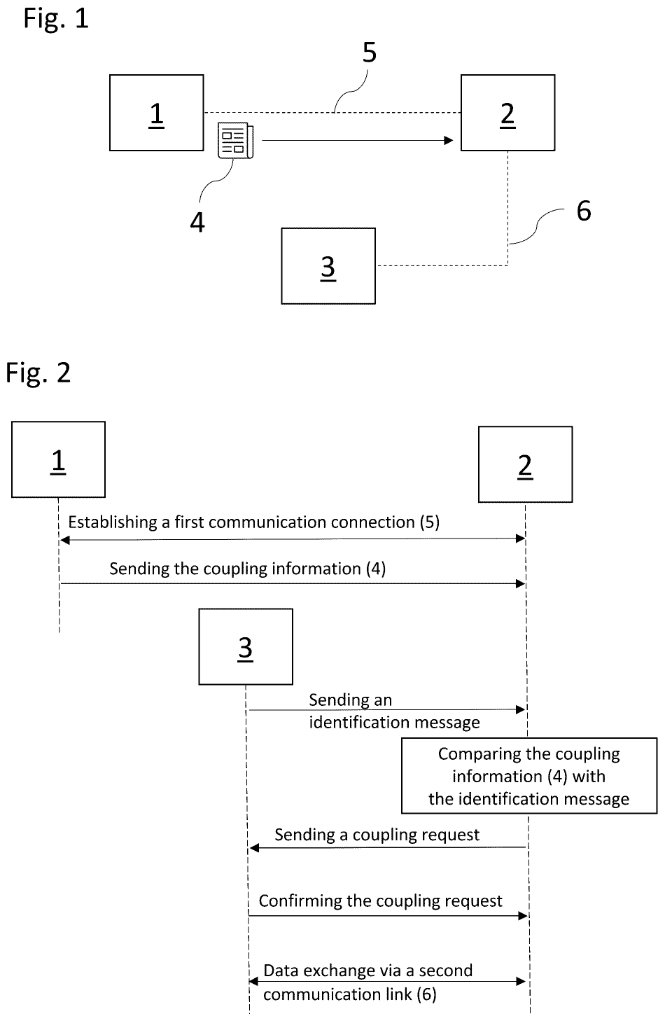

FIG. 1 shows a preferred embodiment of the invention with a first primary functional unit 1, a second primary functional unit 2, and a secondary functional unit 3, each of which is a medical device, in particular a ventilator, an anesthesia device, or an incubator, a sensor for measuring vital parameters, a gas measuring device, a gas sensor or a component of personal protective equipment.

The first primary functional unit 1, the second primary functional unit 2, and the secondary functional unit 3 each comprise a control unit in the form of a microcontroller and at least one communication module, wherein the at least one communication module is configured to transmit data wirelessly via Bluetooth and/or NFC.

The first primary functional unit 1 and the secondary functional unit 3 are already coupled to each other. First, the first primary functional unit 1 is brought by a user into a near field of the second primary functional unit 2 so that the distance between them is less than 10 cm. A first communication link 5 in the form of an NFC connection is then established between the first primary functional unit 1 and the second primary functional unit 2, and the second primary functional unit 2 reads coupling information 4 from the first primary functional unit 1. The coupling information 4 comprises coupling data in the form of a Bluetooth MAC address of the secondary functional unit 3. The second primary functional unit 2 then receives an identification message from the secondary functional unit 3, which comprises the Bluetooth MAC address, and sends a coupling request to the secondary functional unit 3. The secondary functional unit 3 then sends a confirmation of the coupling request to the second primary functional unit 2, whereupon the secondary functional unit 3 and the second primary functional unit 2 are coupled (paired) with each other. The second primary functional unit 2 and the secondary functional unit 3 then exchange data with each other via Bluetooth.

FIG. 2 schematically shows another preferred embodiment of the process according to the invention in a sequence diagram. This sequence diagram shows preferred communication between the first and second primary functional unit 1, 2 and between the second primary functional unit 2 and the secondary functional unit. First, a first communication link 5 is established between the first and second primary functional units 1, 2, wherein the first and second primary functional units 1, 2 have previously been brought into a near field so that their distance from each other is less than 10 cm. The first communication link 5 is an NFC connection via which the first primary functional unit 1 sends coupling information 4 to the second primary functional unit. The coupling information 4 includes a Bluetooth MAC address of the secondary functional unit 3.

The secondary functional unit sends an identification message at recurring intervals, which includes the Bluetooth MAC address of the secondary functional unit 3. The second primary functional unit 2 receives this identification message and compares the Bluetooth MAC address contained therein with the Bluetooth MAC address previously included in the coupling information 4. If both Bluetooth MAC addresses match, the second primary functional unit sends a coupling request to the secondary functional unit 3. The secondary functional unit 3 then sends a confirmation of the coupling request to the second primary functional unit, and the secondary functional unit 3 and the second primary functional unit 2 are coupled with each other. A data exchange then takes place between the secondary functional unit 3 and the second primary functional unit 2 via Bluetooth.

The invention has been described above using preferred embodiments and illustrated in the figures. These descriptions and illustrations are purely schematic and do not limit the scope of protection of the claims, but serve only to illustrate them by way of example. It is understood that the invention can be implemented and modified in many ways and that individual features of the embodiments can be freely combined with each other, provided that this is technically meaningful, without leaving the scope of protection of the patent claims.

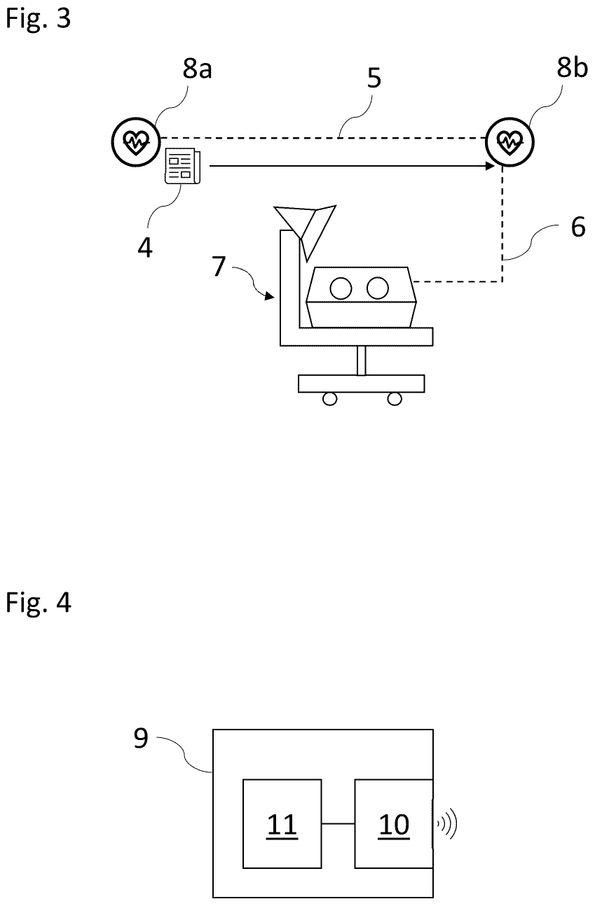

FIG. 3 shows a schematic representation of a system comprising a medical device 7 in the form of an incubator, a first sensor 8a and a second sensor 8b. The first sensor 8a and the second sensor 8b are each a pulse sensor configured to measure a patient's pulse. The first sensor 8a is already coupled to the medical device 7 and is to be replaced by the second sensor 8b. First, the first sensor 8a is brought into a near field of the second sensor 8b so that the first sensor 8a detects the second sensor 8b, whereupon the first sensor 8a establishes a first communication link 5 in the form of an NFC connection with the second sensor 8b and transmits coupling information 4 to the second sensor 8b via the second communication link 5. The coupling information 4 comprises coupling data that enables coupling with the medical device 7. The coupling between the first sensor 8a and the medical device 7 is then released. The second sensor 8b compares the coupling data 5 with that of devices that send an information message via Bluetooth with which the devices can be identified, in particular the medical device 7, and couples with the medical device 7. The second sensor 8b and the medical device 7 are then coupled to each other and exchange data via the second communication link 6.

FIG. 4 shows a preferred embodiment of a functional unit 9 with a communication module 10 and a control unit 11, wherein the communication module 10 and the control unit 11 are connected to each other for data exchange. The communication module is configured to establish a first wireless communication link 5 and/or a second wireless communication link 6 with another functional unit. In this embodiment, the communication module 10 is set up to establish the first communication link 5 in the form of NFC communication and the second communication link in the form of Bluetooth communication. The control unit 11 is configured as a microcontroller, FPGA, or a comparable unit for data processing. The control unit 11 may comprise the communication module 10. The communication module 10 may comprise a first communication module and a second communication module, wherein the first communication module is configured to establish NFC communication and the second communication module is configured to establish Bluetooth communication.

The functional unit 9 according to FIG. 4 is configured and set up, depending on the application, as a first primary functional unit 1, as a second primary functional unit 2 or as a secondary functional unit 3 to execute at least part of the process of one of the previously described embodiments.

While specific embodiments of the invention have been shown and described in detail to illustrate the application of the principles of the invention, it will be understood that the invention may be embodied otherwise without departing from such principles.

### LIST OF REFERENCE CHARACTERS

1 First primary functional unit
2 Second primary functional unit
3 Secondary functional unit
4 Coupling information
5 First wireless communication link
6 Second wireless communication link
7 Medical device
8a First sensor
8b Second sensor
9 Functional unit
10 Communication module
11 Control unit (controller)

What is claimed is:

1. A process for coupling functional units that are configured to communicate wirelessly with each other, the process comprising the steps of:
establishing a first wireless communication link between a first primary functional unit and a second primary functional unit, wherein the first primary functional unit is coupled to a corresponding secondary functional unit;
transmitting coupling information from the first primary functional unit to the second primary functional unit via the first wireless communication link, wherein the coupling information comprises at least coupling data suitable for coupling with the secondary functional unit; and
coupling the second primary functional unit to the secondary functional unit based on the coupling information to establish a second wireless communication link.

2. A process according to claim 1, wherein the first wireless communication link is based on a first communication method and the second wireless communication link is based on a second communication method, wherein the second communication method has a greater maximum radio range than the first communication method.

3. A process according to claim 2, wherein the first communication method is based on a Near Field Communication (NFC) standard.

4. A process according to claim 2, wherein the second communication method is based on a Bluetooth standard.

5. A process according to claim 1, wherein the coupling information is transmitted from the first primary functional unit to the second primary functional unit as soon as the first primary functional unit and the second primary functional unit are in a near field.

6. A process according to claim 1, wherein data transmitted via the second wireless communication link are generated by the second primary functional unit and/or by the secondary functional unit.

7. A process according to claim 1, wherein the coupling information comprises configuration data.

8. A process according to claim 1, wherein the secondary functional unit sends at least one identification message which is received by the second primary functional unit.

9. A process according to claim 1, wherein the second primary functional unit sends at least one coupling request which is received by the secondary functional unit, wherein the coupling request comprises at least part of the coupling information.

10. A process according to claim 1, wherein the coupling information comprises a universally unique identifier (UUID), wherein the UUID is configured for identifying a wireless communication link.

11. A process according to claim 1, wherein the coupling of the second primary functional unit and the secondary functional unit is confirmed by an input message to the second primary functional unit and/or by an input message to the secondary functional unit before the second wireless communication link is established.

12. A process according to claim 1, wherein at least the second primary functional unit and the secondary functional unit each have a signal output element and output a same signal as soon as the second primary functional unit and the secondary functional unit are coupled to each other.

13. A system comprising:
a first primary functional unit, which comprises a control unit and a communication module that is configured to establish a wireless communication link;
a second primary functional unit, which comprises a control unit and a communication module that is configured to establish a wireless communication link;
a secondary functional unit, which comprises a control unit and a communication module that is configured to establish a wireless communication link,
wherein with the first primary functional unit coupled to the secondary functional unit, the first primary functional unit and the second primary functional unit are configured to establish a first wireless communication link between the first primary functional unit and the second primary functional unit and transmit coupling information from the first primary functional unit to the second primary functional unit via the first wireless communication link, wherein the coupling information comprises at least coupling data configured for coupling with the secondary functional unit and wherein the second primary functional unit and the secondary functional unit are configured to couple to establish a second wireless communication link, with the second primary functional unit coupled to the secondary functional unit based on the coupling information received from the first primary functional unit.

14. A system according to claim 13,
wherein the first primary functional unit and the second primary functional unit comprise a medical device and/or a sensor for detecting vital parameters, and
wherein the secondary functional unit comprises a medical device and/or a sensor.

15. A system according to claim 13,
wherein the first primary functional unit and the second primary functional unit comprise personal protective equipment, a gas measuring device and/or a gas sensor, and
wherein the secondary functional unit comprises personal protective equipment, a gas measuring device and/or a gas sensor.

16. A system according to claim 13, wherein the first wireless communication link is based on a first communication method and the second wireless communication link is based on a second communication method, wherein the second communication method has a greater maximum radio range than the first communication method.

17. A system according to claim 16, wherein the first communication method is based on a Near Field Communication (NFC) standard and wherein the second communication method is based on a Bluetooth standard.

18. A system according to claim 13, wherein the first primary functional unit and the second primary functional unit are configured such that the coupling information is transmitted from the first primary functional unit to the second primary functional unit as soon as the first primary functional unit and the second primary functional unit are in a near field.

19. A system according to claim 13,
wherein the second primary functional unit sends at least one coupling request, which is received by the secondary functional unit, wherein the coupling request comprises at least part of the coupling information;
wherein the coupling information comprises configuration data;
wherein the secondary functional unit sends at least one identification message which is received by the second primary functional unit; and
wherein data transmitted via the second wireless communication link are generated by the second primary functional unit and/or by the secondary functional unit.

20. A functional unit comprising:
a communication module; and
a control unit, wherein the control unit is configured to:
establish a first wireless communication link with a first primary functional unit, wherein the first primary functional unit is coupled to a secondary functional unit;
receive coupling information from the first primary functional unit via the first wireless communication link, wherein the coupling information comprises at least coupling data configured for coupling with the secondary functional unit; and
couple with the secondary functional unit based on the coupling information to establish a second wireless communication link with the secondary functional unit.
